(19) United States
(12) Patent Application Publication
(10) Pub. No.: US 2005/0149939 A1
(43) Pub. Date: Jul. 7, 2005

(54) Method and device for managing resources in a computer system

(76) Inventors: Carsten Noeske, Sexau (DE); Ralf Herz, Freiburg (DE); Franz-Otto Witte, Teningen (DE)

Correspondence Address: Patrick J O'Shea;Gauthier & Connors, Suite 3300, 225 Franklin Street, Boston, MA, 02110, US

(21) Appl. No.: 10/498,893

(22) PCT Filed: Dec. 20, 2002
(86) PCT No.: PCT/EP02/14657

(30) Foreign Application Priority Data
Dec. 21, 2001 (DE) 101 63 695.4

(51) Int. Cl. G06F 9/46

(52) U.S. Cl. 718/104

(57) ABSTRACT

The invention relates to a method, and to a device for implementing the method, for managing resources in a computer system in which a plurality of resources is available to execute programs, wherein at least some of the resources are used temporarily or permanently by an executed program, said method comprising the steps of: a) requesting at least one of the resources for allocation to the program, c) saving the resource to be allocated for subsequent restoration of the resource, d) allocating the requested resource to the program, and e) usage of the allocated resource by the program. Resource management is advantageously improved by b) verifying the usage status of the allocated resource, and b1) either: if the resource to be allocated is not in use, proceeding with the allocation and use of the allocated resource (e), b2) or: if the resource to be allocated is in use, proceeding to save (c), and subsequently to allocate (d) and use (e), the allocated resource.

The invention relates to a method for managing resources in a computer system comprising the features in the preamble of Claim 1, or to a device for managing resources in a computer system comprising the features in the preamble of Claim 6. The invention thus relates specifically to a device for managing hardware resources such as registers, pointers, or the like, so as to optimize the computing performance of processors.

In the course of developing new programming techniques and programming languages over the last few years, a clear trend has emerged in the direction of modular and object-oriented programming. The advantages of object-oriented programming relate less to achievable computing performance than to structuring and maintainability of large software projects. The modularization aspect involves combining logical blocks into subroutine units with a defined start address which may be called up from different program positions. The aspect of object-orientation is essentially manifested in a combination of data regions and subroutines into objects from which multiple instances of a similar object type can be generated and extended by different access restrictions and object-inheritance methods such as that described, for example, by Bjarne Stroustroup in “The C++ Programming Language.”

Both programming concepts make extensive use of the “stack,” a memory structure or data structure in which data are stored in a stack. The basic principle of the stack is that the value last placed on the stack must be the first value retrieved therefrom. In response to a subroutine call, for example, the return address for the subroutine is placed on the stack.

The use of the stack is quite flexible; however, its use requires frequent memory access, something which causes a bottleneck for data throughput and affects the performance of the arithmetic and logic unit due to the resulting latency period and to the resulting high power consumption as well as limited bandwidth of the processor busses.

In order to avoid these disadvantages, the implementation of computer systems or arithmetic and logic units frequently employs local resources such as accumulators, registers, or pointers which do not have the disadvantages of the stack.

The use of local resources, however, presents a problem in terms of modular programming techniques due to the fact that at the time the program is compiled, the current status or use of hardware resources is unknown. In order nevertheless to be able to work with modular structures, the programmer of a subroutine or compiler must ensure either that the resources are available in a restored state or that the resources are saved to the written stack before calling the subroutine—and may be restored after its execution. The latter procedure is standard in currently available processors. The routines for saving local resources are called a “spill code.” As is readily evident, part of the performance increase expected by providing the hardware resources is compensated by the spill code, especially in the case of short subroutines. One particular disadvantage here is that local resources must be saved in expensive fashion merely, as it were, on suspicion of this requirement, even if these in fact prove to be available.

The difficulty described above is distinguished specifically by the fact that when using modular or object-oriented techniques, especially iterations or recursions, it is not possible for a programmer to have any information as to the status of processor resources at the run time for his routine.

The goal of the invention is to propose a method or a device for managing resources in a computer system, which method or device provides for efficient management of the available resources.

This goal is achieved by the method for managing resources in a computer system, which method has the features of Claim 1, or by a device for managing resources in a computer system, which device has the features of Claim 6.

The starting point here is a method for managing resources in a computer system in which a plurality of resources are available to execute programs, wherein at least some of the resources are being used temporarily or permanently by this executed program. The allocation of resources has steps which are known per se. These include, after requesting at least one of the resources for allocation to the program, usually saving the resource to be allocated for later restoration. After saving the resource to be allocated, the requested resource is allocated to the requesting program which then uses the specific resource.

In order to manage resources more efficiently, after at least one of the resources has been requested the step by which the use of the allocated resource is verified is inserted. Depending on the result of this verification, in the event the resource to be allocated is either completely or partially in use, the operation proceeds to save, and subsequently to allocate and use, the resource. If the resource to be allocated is not being used, namely, is free, the operation omits the step of saving the resource to be allocated and proceeds instead to use the resource allocated.

The resources are accordingly saved only when this is in fact necessary. In those cases when saving may be omitted, a plurality of storage steps, i.e. data exchange measures that would be both time-intensive and also use up computer capacity, may also be eliminated.

The program may be software code; however, the approach in the more general sense also involves read-only programs which, when a hardware device is connected to a computer, for example, trigger actions in the computer or its computing device as retrieved from the read-only memory of the hardware device.

A corresponding device for managing resources in a computer system accordingly has at least one memory location in the form of a pointer memory location to store a pointer value, specifically an address of the resource quantity, at least one availability counter with availability information to indicate the quantity of available resources, a resource determination device to evaluate and update the position of the counter and of the availability information, a resource usage device to use and/or deallocate resources, and a stack to receive the content of resources used at the time of a resource request. In order to improve resource management, the device has a decision device to decide whether a requested resource is free or in use, after which the decision device, especially in the form of a resource computer, in the event of a free and previously unused resource, directly allocates the requested resource. Alternatively, after transfer of the previously used resource to the stack so that the resource content is saved, the resource is allocated to the requesting device or requesting program in the procedure known from the prior art. Here, some or all of the individual devices listed may be integrated as hardware, functions, or programs within a processor.

Advantageous embodiments are the subject of the dependent claims.

Advantageously, the resources allocated comprise local hardware resources of the computer, also including all types of processors with available processor resources. In the case of a plurality of different resources, such as accumulators, registers, and pointers as resources, the different resources are divided into resource classes and advantageously managed separately from each other. Corresponding memory locations are provided to store resource pointers which point to the corresponding resource classes. Advantageously, only those resources are addressed in the procedure which have been previously requested by a resource management or the central processor for specific tasks, especially programs.

Since time is needed whenever a requested resource is in use and must therefore be saved by the stack, an interrupt logic then issues an interrupt, i.e., an interrupt signal, to interrupt the program operation for the period of storage to the stack or afterwards for restoration.

The resource management is thus a unit that monitors the state of resources during the run time and enables the program/programmer to use hardware resources efficiently when these are being requested by the processor.

If the requested resources are not locally in use, then they are allocated immediately, i.e., without any unnecessary saving and restoration measures. The otherwise routinely implemented saving procedure is performed only if a local resource is being used during the run time.

The resource management thus achieves a significant reduction in unnecessary data transfers while providing sufficient local resources. As a result, computing performance is increased, while performance utilization by the arithmetic and logic unit is reduced. It is not uncommon for over 30% of the computing time to be required to execute the “spill code” without this proposed resource management.

The advantages of using local resources remain intact, even if they cannot all be addressed simultaneously through the standard instruction code. It is quite sufficient only to address those local resources that can be requested through the resource management for a specific task. As a result, valuable space within the instruction code of the processor can be saved, thereby reducing the memory requirement of programs.

One embodiment is explained in more detail below based on the drawings.

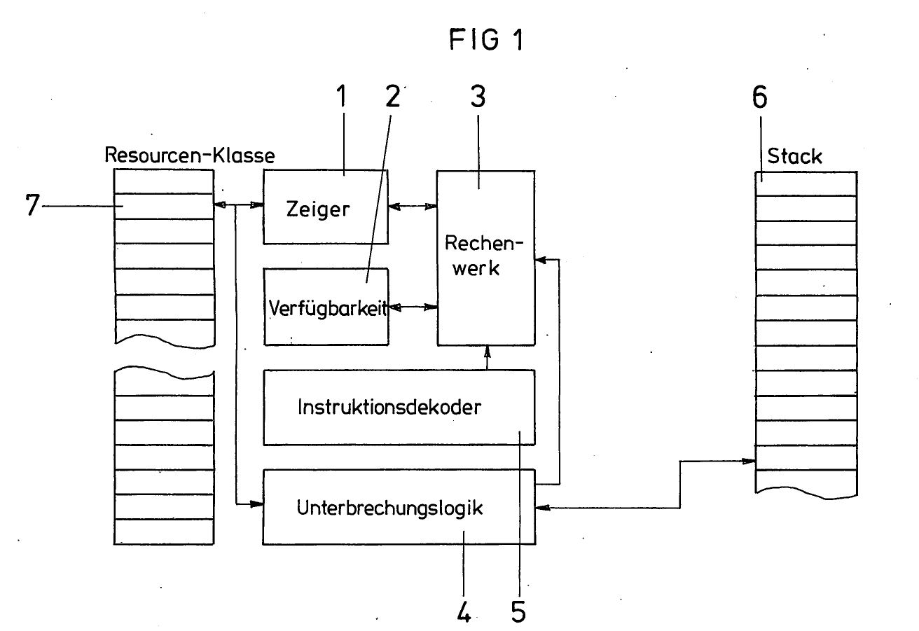

FIG. 1 is a schematic view of selected components of a circuit for a device to manage resources in a computer system; and

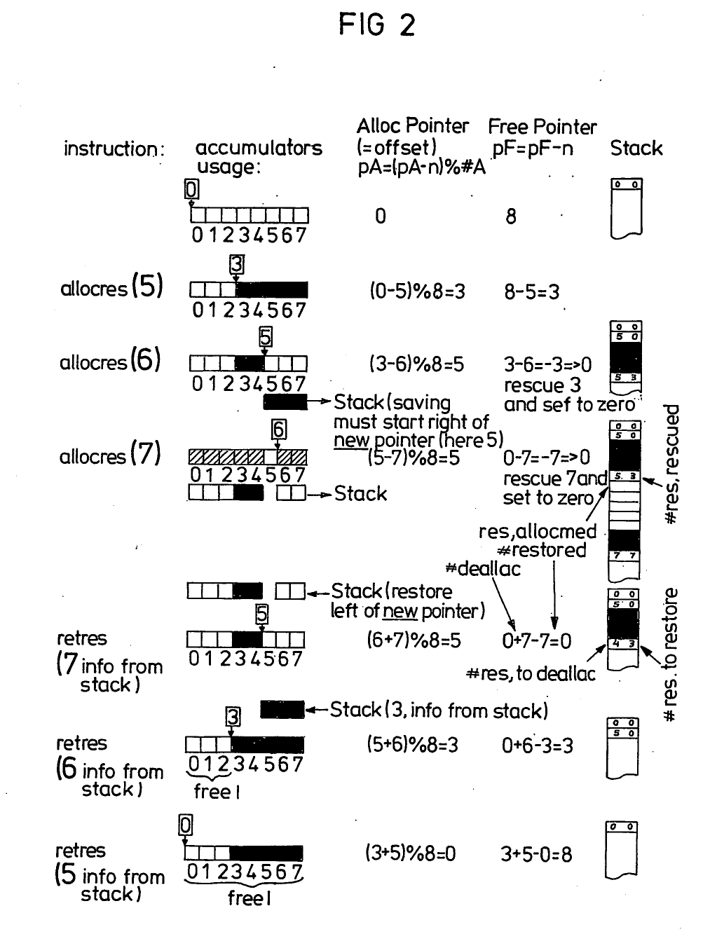

FIG. 2 shows usage states of memories and parameter states in an exemplary resource management cycle.

The functional principle of resource management is based on the idea of expanding the memory stack by the elements of one resource class. Resource classes here mean similar resources, for example accumulators, that are functionally interchangeable.

The resource management function is based on a combination of different components listed below. FIG. 1 is a schematic view of selected components in a computer system or processor kernel with integrated and connected circuit components that are advantageous in understanding resource management. This system has active circuit elements such as an arithmetic and logic unit 3, an instruction decoder 4, and an interrupt logic 5. In addition, partially active or passive circuit elements are provided, such as a memory 1 to store one or more pointer values, an availability counter 2 to store one or more units of availability information, a memory 7 as the resource class memory, and a stack 6 to receive or save the content of resources. The various memory devices 1, 2, 7, 6 may also be individual memory segments of a single memory, or of multiple higher-level memories.

The most important circuit components and their functions are listed below.

1. For each resource class, a local resource pointer 1 is used which has the property that its addressing is implemented in an annular and/or modular approach as a function of the resource quantity. An access by the processor, specifically, by a higher-level processor or arithmetic and logic unit 3 to elements of a resource class, is advantageously always implemented relative to resource counter 1, and also in an annular or modular fashion.

2. In addition, a reliability information unit, also called a FreePointer, is stored in availability counter 2, which unit indicates how many of the total available components of a local resource class are available, i.e., not in use by previous operations.

3. In addition, for each resource class a local resource arithmetic and logic unit 3 is provided which evaluates and updates the position of the resource pointer and the content of the FreePointer.

4. Instructions to request or deallocate resources are implemented in instruction decoder 4 of the processor.

5. An interrupt logic 5 comes into use whenever the local resources of at least one class are not sufficient for a request.

6. In addition, there is a stack 6 that receives the content of local resources whenever the arithmetic and logic unit 3 resource determines in response to a request that insufficient local resources of a class are present.

7. Resource class memory 7, which serves to allocate resource classes, is also advantageously provided. Within a resource class, different resources, such as registers, pointers, or accumulators, are combined, which may in some cases be represented in multiple form within the system and thus advantageously allow for common management.

A resource management operation is started when a resource request is made by the program running in the processor or computer system, which request is evaluated by instruction decoder 4.

The request information for the one resource, or usually multiple resources, here contains the number of required resources of a class, which is advantageously always less than or equal to the total number of local resource elements, and the type of the resource class. Resources of multiple classes may advantageously be requested with one instruction.

The number of needed resources is then passed on by instruction decoder 4 to resource arithmetic and logic unit 3 which reduces availability counter 2 by the number of requested resources then reduces the resources pointer in pointer memory location 1 by the corresponding value.

If, after completion of this operation, the value of the availability pointer remains positive, the resource request is then completed by the corresponding resource allocation to the requesting program.

A deallocation of resources, for example after executing the program that requests the resource and to which the resource has been allocated, is implemented in complementary form, i.e., the values of both counters 1, 2 are again raised.

If after completion of the operation the value of the availability counter becomes negative, then elements of the local resources must be rescued to the stack 6. This rescue operation requires several clock cycles and thus requires an interrupt of the normal program operation. An interrupt request (interrupt) is thus triggered during which a special routine is started in which the necessary rescue measures are programmed. This routine evaluates availability counter 2, then saves the negative number of memory cells indicated in availability counter 2 on the stack, beginning with the position of the resource pointer. As the last unit of information, the number of rescued resources is rescued to the stack.

The interrupt routine may be operated on the basis of software or hardware. In the system illustrated, it is represented by interrupt logic 5 which is connected to arithmetic and logic unit 3 and memory 1 for the pointer.

The value of the availability counter 2 is then set to zero.

In terms of deallocation of resources, the top element of the stack is now evaluated first. If the value found there is not equal to zero, an interrupt routine is again called up which implements the complementary operations, i.e., the restoration of the local resources and correction of the availability counter and resource counter values.

In a practical implementation of the resource management, a situation may occur in which, for deeply nested programs, all local resources are in use and stack operations are required for every request.

This situation can be easily prevented, however, by inserting, for example, a manual resources deallocation at “strategically appropriate” positions, such as at the beginning of larger program blocks. At the end of such a block, the previous state is restored.

FIG. 2 illustrates a practical example of a resource management cycle. The first column provides the instruction which is issued by instruction decoder 4.

The second column shows, from top to bottom, the chronological sequence of the usage of requested resources, provided as an example (accumulator usage). In the example shown, the resource has 8 memory locations, where the value of pointer memory location 1 for the access point to free memory locations is shown above these memory locations. Empty boxes indicate free memory locations, while filled boxes indicate occupied memory locations.

The third column contains the respective value of the availability counter or usage pointer (AllocPointer); in other words, its shows an offset. The fourth column contains the value of the FreePointer, i.e., the value of the availability information in availability counter 2 for this resource. The last column shows the usage status in the stack 6.

In a first method step, it is assumed that the resource is unused, i.e., free. Accordingly, the value of the usage memory or pointer is 0, so that in response to a request the first resource 0 would be allocated. The availability information is thus equal to the value of the available memory locations, i.e., 8, and the stack in stack 6 is empty.

After a usage request for five resource memory locations (Allocres (5)), the five highest-value bits are allocated to the requesting program or to the requesting device, after which the value of the usage pointer is set to three, while the value of the availability information is also set to three. The memory in stack 6 continues to remain unused.

After another resource request for six resource memory locations (Allocres (6)), the value of the usage pointer, i.e., pointer memory locations 3-6=5 and the value of the availability information after subtraction of the requested value 6 from the available resource locations 3 is now −3. Three more resource memory locations are thus requested than are available in the resource. Accordingly, the known approach of saving three resource memory locations in stack 6 is used. The value of the availability information in availability counter 2 is then set to zero, while the usage pointer remains at value 5. During the saving operation into stack 6 for the resource memory locations to be allocated, the resource locations to the right of the new usage pointer location are saved.

After another request for, for example, resource memory locations (Allocres (7)), another saving operation into stack 6 is implemented, whereby seven values of the resource are saved.

In the example shown of the resource management cycle, execution of the individual requesting programs or device requests is then implemented, and the resources are thus deallocated. In terms of restoration, this occurs in a reverse procedure relative to the previous storage.

First, seven resource memory locations are thus deallocated, i.e., the first seven values of stack 6 are written back to the resource. In a manner known from the prior art, the circuit or software running on it recognizes how many values must be restored from stack 6 based on the information saved together with the values indicating the number of values. At the same time, this number is used to determine the new availability information or new FreePointer.

After executing the respective program, the next six values from stack 6 are restored and the availability information is accordingly recalculated, this information now receiving the value 3. In a last step, after execution of the assigned program, the last program requesting resources is executed so that finally both stack 6 as well as the memory locations of the resource are free of stored values.

The last three lines show the usage of the resource at the beginning of restoration, while the calculations and values upon completion of the restoration and execution are indicated for the usage pointer (AllocPointer) and the availability counter (FreePointer).

1. Method for managing resources in a computer system in which a plurality of resources is available to execute programs, wherein at least a portion of the resources is temporarily or permanently in use by this executed program, comprising the steps:
a) requesting at least one of the resources for allocation to the program;
c) saving the resource to be allocated for later restoration;
d) allocating the requested resource to the program; and
e) usage of the allocated resource by the program, characterized by
b) verifying the usage status of the resource to be allocated, and
b2) either: if the resource to be allocated is not in use, proceeding with the allocation and use of the allocated resource (d, e),
b2) or: if the resource to be allocated is in use, proceeding to save (c), and subsequently to allocate (d) and use (e), the allocated resource.

2. Method according to claim 1, wherein local hardware resources of the computer are allocated as the resource.

3. Method according to claim 1, wherein only those resources that can be requested through a resource management for specific tasks are addressed.

4. Method according to claim 1, wherein similar resources are assigned to their own specific resource classes.

5. Method according to claim 4, wherein one resource counter is assigned to each resource class, the addressing of this resource counter being implemented in an annular modular manner as a function of the resource quantity.

6. Device for managing resources in a computer system in which a plurality of resources is available to execute programs, wherein at least a portion of the resources is temporarily or permanently in use by this executed program, comprising
at least one memory location as the pointer memory location (1) to store a pointer value (AllocPointer), especially to store an address or position of the resource quantity,
at least one availability counter (2) including availability information (FreePointer) to indicate the quantity of available resources;
a resource determination device, specifically, an arithmetic and logic unit (3) for evaluating and updating the pointer value and the availability information;
a resource usage device for using and/or deallocating the resources; and
a stack (6) for receiving the content of the resources, characterized by
a decision device (3) to decide whether a requested resource is free or in use, and either to directly allocate a free resource or to allocate a previously used resource after transfer of the previously used resource to the stack (6).

7. Device according to claim 6, comprising an interrupt logic (5) to interrupt the allocation of a resource to a requesting program if the available resources are insufficient to respond to the request.

8. Device according to claim 6, comprising at least two, particularly a plurality, of memory locations (1, 2, 7) to store one each of the different storage values, the storage values pointing to the addresses of different resources.

9. Device according to claim 8, wherein the different resources belong to different resource types, those of each type being combined into one resource class.
